(19) United States
(12) Patent Application Publication
(10) Pub. No.: US 2011/0161073 A1
(43) Pub. Date: Jun. 30, 2011

(54) SYSTEM AND METHOD OF DISAMBIGUATING AND SELECTING DICTIONARY DEFINITIONS FOR ONE OR MORE TARGET WORDS

(75) Inventors: GREG LESHER, PITTSBURGH, PA (US); BOB CUNNINGHAM, PITTSBURGH, PA (US)

(73) Assignee: DYNAVOX SYSTEMS, LLC, PITTSBURGH, PA (US)

(21) Appl. No.: 12/648,629

(22) Filed: Dec. 29, 2009

(51) Int. Cl. G06F 17/21

(52) U.S. Cl. 704/10; 704/E11.001

(57) ABSTRACT

Systems and methods for automatically selecting dictionary definitions for one or more target words include receiving electronic signals from an input device indicating one or more target words for which a dictionary definition is desired. The target word(s) and selected surrounding words defining an observation sequence are subjected to a part of speech tagging algorithm to electronically determine one or more most likely part of speech tags for the target word(s). Potential relations are examined between the target word(s) and selected surrounding keywords. The target word(s), the part of speech tag(s) and the discovered keyword relations are then used to map the target word(s) to one or more specific dictionary definitions. The dictionary definitions are then provided as electronic output, such as by audio and/or visual display, to a user.

### CROSS-REFERENCE TO RELATED APPLICATIONS

N/A

### STATEMENT REGARDING FEDERALLY SPONSORED RESEARCH OR DEVELOPMENT

N/A

### BACKGROUND

The presently disclosed technology generally pertains to systems and methods for linguistic analysis, and more particularly to features for automatically disambiguating among dictionary definitions for selected electronic presentation to a user.

In many software-based electronic reading and/or writing applications, such as but not limited to word processing programs, web browsers, communications applications and the like, users may seek to obtain a dictionary definition for words that are used in such applications. Electronic dictionaries are available, but are usually limited in their capabilities to accurately determine the correct definition for a given word used in context. In other words, dictionary definitions for a given word usually include definitions for all possible word senses/meanings for a given word and do not further disambiguate among the different possible senses/meanings. As such, the use of an electronic dictionary may retain some of the same limitations as a conventional printed dictionary.

The disadvantages of known conventional printed and/or electronic dictionaries may be particularly cumbersome for applications in which dictionary definitions are provided as text output for a user. If multiple definitions are presented for a word, a user may often be inundated with information of which only a portion is relevant for his intended purpose of determining an appropriate contextual definition. If all such definitions are provided as visual output, the user would then have to read through several definitions to try and select the best one for his purposes. If such definitions are provided as audio output, the burden on a user is exacerbated because he must expend the time required to listen to all the definitions as they are read to a user.

An example of a device in which audio output can be critical for user interaction is an electronic device known as a speech generation device (SGD) or Alternative and Augmentative Communication (AAC) device. In general, a speech generation device may include an electronic interface with specialized software configured to permit the creation and manipulation of digital messages that can be translated into audio speech output. SGDs and AAC devices are becoming increasingly advantageous for use by people suffering from various debilitating physical conditions, whether resulting from disease or injuries that may prevent or inhibit an afflicted person from audibly communicating. For example, many individuals may experience speech and learning challenges as a result of pre-existing or developed conditions such as autism, ALS, cerebral palsy, stroke, brain injury and others. In addition, accidents or injuries suffered during armed combat, whether by domestic police officers or by soldiers engaged in battle zones in foreign theaters, are swelling the population of potential users. Persons lacking the ability to communicate audibly can compensate for this deficiency by the use of speech generation devices.

In order to better facilitate the use of electronic dictionaries with electronic devices, including speech generation devices, which use word processing, communication or other text-based applications, a need continues to exist for refinements and improvements to the ability to properly disambiguate among multiple word sense entries for a given dictionary word entry. While various implementations of electronic dictionary systems and methods have been developed, no design has emerged that is known to generally encompass all of the desired characteristics hereafter presented in accordance with aspects of the subject technology.

### BRIEF SUMMARY

In general, the present subject matter is directed to various exemplary electronic dictionary systems and methods for selecting dictionary definitions for presentation to a user. More particularly, features and steps are provided for disambiguating among multiple dictionary definitions using part of speech and word relation analysis.

In one exemplary embodiment, a method of automatically selecting dictionary definitions for one or more target words includes a first step of receiving electronic signals from an input device identifying one or more target words for which a dictionary definition is desired. Target words may be provided by a user as electronic input to a processing device or may be selected from pre-existing, downloaded, imported or other electronic data accessible by a processing device. The target words are preferably provided in context such that subsequent part of speech analysis and word relation analysis can consider not only a target word for which a dictionary definition is desired, but surrounding words in a sentence, phrase, or other sequence of words.

A first aspect of target word analysis may involve assigning one or more most likely part of speech tags to the one or more target words. In one example, the target words and surrounding words constituting a sentence or other observation sequence are subjected to a part of speech tagging algorithm to electronically determine the one or more most likely part of speech tags for the target word(s). Different algorithms, such as but not limited to first-order Viterbi, second-order Viterbi, and forward-backward algorithms may be utilized in the part of speech tagging.

A second aspect of target word analysis may involve a determination of potential relations among the target words and selected surrounding words (i.e., keywords) in a sentence or other observation sequence. Such words or corresponding word senses may be potentially related to one another by type (e.g., kind of, part of, opposite of, used in, etc.) or other preconfigured or customizable factors.

Referring still to exemplary methods of the subject dictionary definition presentation, a step of electronically mapping the one or more target words to one or more specific dictionary definitions is implemented. The mapping involves a consideration of the target word itself, the part of speech tags and/or the determined relations between the target word and surrounding keywords. Different selectable combinations of these factors by way of probability analysis or other rules may be employed in the mapping process. The selected dictionary definitions may then be provided as physical output to a user, such as by visual output on an electronic display or audio output via a speaker or other suitable device.

It should be appreciated that still further exemplary embodiments of the subject technology concern hardware and software features of an electronic device configured to perform various steps as outlined above. For example, one exemplary embodiment concerns a computer readable medium embodying computer readable and executable instructions configured to control a processing device to implement the various steps described above or other combinations of steps as described herein.

In a still further example, another embodiment of the disclosed technology concerns an electronic device, such as but not limited to a speech generation device, including such hardware components as a processing device, at least one input device and at least one output device. The at least one input device may be adapted to receive electronic input from a user regarding selection or identification of one or more target words for which dictionary definition lookup is desired. The processing device may include one or more memory elements, at least one of which stores computer executable instructions for execution by the processing device to act on the data stored in memory. The instructions adapt the processing device to function as a special purpose machine that assigns one or more most likely part of speech tags to the one or more target words, determines relations among the one or more target words and surrounding keywords, and maps the one or more target words to one or more specific dictionary definitions based on each target word, the one or more most likely part of speech tags and the determined relations for each target word. Once one or more specific dictionary definitions for the target word(s) are identified, the at least one electronic output device may visually display and/or audibly output the target word(s) and definitions to a user.

Additional aspects and advantages of the disclosed technology will be set forth in part in the description that follows, and in part will be obvious from the description, or may be learned by practice of the technology. The various aspects and advantages of the present technology may be realized and attained by means of the instrumentalities and combinations particularly pointed out in the present application.

### BRIEF DESCRIPTION OF THE DRAWINGS

The accompanying drawings, which are incorporated in and constitute a part of this specification, illustrate one or more embodiments of the presently disclosed subject matter. These drawings, together with the description, serve to explain the principles of the disclosed technology but by no means are intended to be exhaustive of all of the possible manifestations of the present technology.

FIG. 1 provides a flow chart of exemplary steps in a method of automatic dictionary definition disambiguation applied to one or more target words;

FIG. 2A provides a flow chart of exemplary steps in a part of speech tagging algorithm by which parts of speech are assigned to words in an observation sequence, including one or more target words;

FIG. 2B provides a flow chart of exemplary steps in a process of determining potential relations between target word(s) and selected surrounding keyword(s) in an observation sequence;

FIG. 3 provides a schematic view of exemplary relations among target word sense(s) and related word sense(s), such as may be analyzed in the relation determination steps of FIG. 2B;

FIG. 4 provides a schematic view of exemplary hardware components for use in an exemplary electronic device having dictionary disambiguation features in accordance with aspects of the presently disclosed technology; and

FIG. 5 provides a schematic view of exemplary hardware components for use in an exemplary speech generation device having dictionary disambiguation features in accordance with aspects of the presently disclosed technology.

### DETAILED DESCRIPTION OF THE PREFERRED EMBODIMENTS

Reference now will be made in detail to the presently preferred embodiments of the disclosed technology, one or more examples of which are illustrated in the accompanying drawings. Each example is provided by way of explanation of the technology, which is not restricted to the specifics of the examples. In fact, it will be apparent to those skilled in the art that various modifications and variations can be made in the present subject matter without departing from the scope or spirit thereof. For instance, features illustrated or described as part of one embodiment, can be used on another embodiment to yield a still further embodiment. Thus, it is intended that the presently disclosed technology cover such modifications and variations as may be practiced by one of ordinary skill in the art after evaluating the present disclosure. The same numerals are assigned to the same or similar components throughout the drawings and description.

The technology discussed herein makes reference to processors, servers, memories, databases, software applications, and/or other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computer-implemented processes discussed herein may be implemented using a single server or processor or multiple such elements working in combination. Databases and other memory/media elements and applications may be implemented on a single system or distributed across multiple systems. Distributed components may operate sequentially or in parallel. All such variations as will be understood by those of ordinary skill in the art are intended to come within the spirit and scope of the present subject matter.

When data is obtained or accessed between a first and second computer system, processing device, or component thereof, the actual data may travel between the systems directly or indirectly. For example, if a first computer accesses a file or data from a second computer, the access may involve one or more intermediary computers, proxies, or the like. The actual file or data may move between the computers, or one computer may provide a pointer or metafile that the second computer uses to access the actual data from a computer other than the first computer.

The various computer systems discussed herein are not limited to any particular hardware architecture or configuration. Embodiments of the methods and systems set forth herein may be implemented by one or more general-purpose or customized computing devices adapted in any suitable manner to provide desired functionality. The device(s) may be adapted to provide additional functionality, either complementary or unrelated to the present subject matter. For instance, one or more computing devices may be adapted to provide desired functionality by accessing software instructions rendered in a computer-readable form. When software is used, any suitable programming, scripting, or other type of language or combinations of languages may be used to implement the teachings contained herein. However, software need not be used exclusively, or at all. For example, as will be understood by those of ordinary skill in the art without required additional detailed discussion, some embodiments of the methods and systems set forth and disclosed herein also may be implemented by hard-wired logic or other circuitry, including, but not limited to application-specific circuits. Of course, various combinations of computer-executed software and hard-wired logic or other circuitry may be suitable, as well.

It is to be understood by those of ordinary skill in the art that embodiments of the methods disclosed herein may be executed by one or more suitable computing devices that render the device(s) operative to implement such methods. As noted above, such devices may access one or more computer-readable media that embody computer-readable instructions which, when executed by at least one computer, cause the at least one computer to implement one or more embodiments of the methods of the present subject matter. Any suitable computer-readable medium or media may be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other solid-state memory devices, and the like.

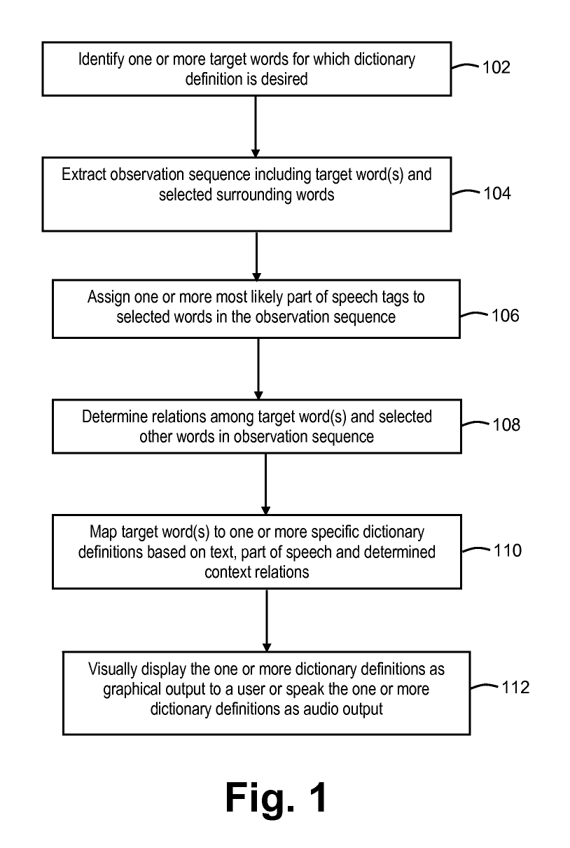

Referring now to the drawings, FIG. 1 provides a schematic overview of an exemplary method for using part of speech and word sense relations to automatically disambiguate among multiple possible dictionary definitions in an electronic application. In general, word sense disambiguation involves identifying one or more most likely choices for a word sense used in a given context, when the word/text itself has a number of distinct senses.

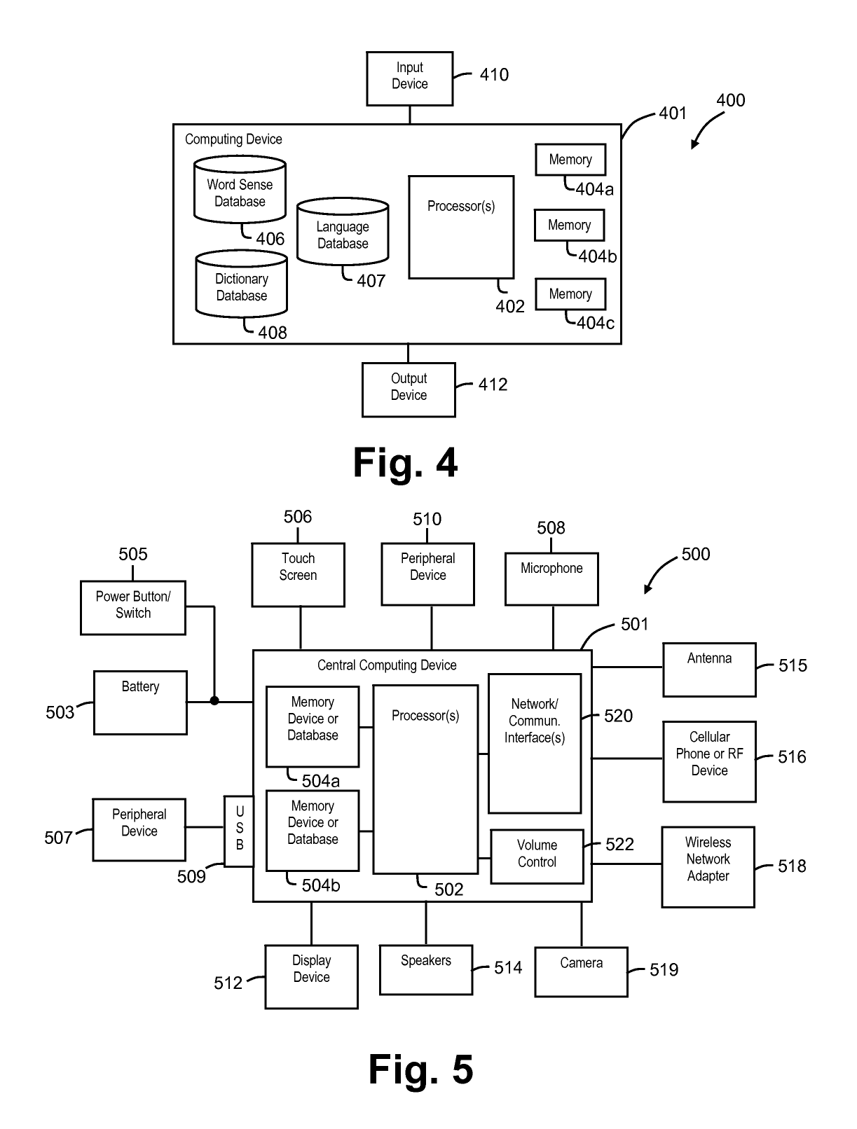

The steps provided in FIG. 1 and other figures herein may be performed in the order shown in such figure or may be modified in part, for example to exclude optional or non-optional steps or to perform steps in a different order than shown in such figures. The steps shown in FIG. 1 are part of an electronically-implemented computer-based algorithm. Computerized processing of electronic data in a manner as set forth in FIG. 1 may be performed by a special-purpose machine corresponding to some computer processing device configured to implement such algorithm. Additional details regarding the hardware provided for implementing such computer-based algorithm are provided in FIGS. 4 and 5.

A first exemplary step 102 in the method of FIG. 1 is to receive and/or otherwise identify one or more target words for which a dictionary definition is desired. The target word(s) can correspond to electronic text that may be provided by a user as electronic input to a processing device or may be selected from pre-existing, downloaded, imported or other electronic data accessible by a processing device. In most embodiments, the target word(s) will be part of additional electronic text such that the target word(s) are available in context of use with additional surrounding words or text. Step 104 then involves extracting an observation sequence including the target word(s) and selected surrounding words from such contextual environment. For example, the observation sequence may include the sentence in which the target word(s) are used or some other plurality of words strung together in one or more sentences, portions of sentences, clauses or other subset of words. Some of the following description may discuss the observation sequence as a sentence, although it should be appreciated that other subsets of words/text may be analyzed herein.

Referring still to FIG. 1, steps 106 and 108 generally concern various features that contribute to the ability of the electronic system to automatically disambiguate among different possible dictionary definitions for the target word(s). Step 106 involves determining appropriate part of speech information for the target word(s). Step 108 analyzes possible word sense relations among the target word(s) and surrounding words in context.

A variety of different models and methods can be used to implement the part of speech tagging in step 106 of FIG. 1. In general, a part of speech tagging algorithm assigns each word in a sentence or other subset of text with a tag describing how that word is used in context. The set of tags assigned by a part of speech tagger may contain just a few tags or many hundreds of tags. In one example, tagsets used for English language tagging may include anywhere between 20-100 tags or more, or between 50-150 tags in another example. Larger tagsets with several hundred tags may be used for morphologically rich languages like German, French, Chinese, etc. where the number, gender and case features of nouns, adjectives, and determiners lead to a wide variety in the number of possible tags. One example as set forth below in Table 1 is the CLAWS5 (Constituent Likelihood Automatic Word-tagging System) tagset developed by UCREL of Lancaster University in Lancaster, United Kingdom. It should be appreciated that such exemplary tagset and others as may be utilized herein include a sufficient amount of tags to distinguish among different basic parts of speech as well as syntactic and/or even morpho-syntactic distinctions among such parts of speech.

TABLE 1
Exemplary Tagset with Part of Speech Tags

| Taq: | Taq Type/Description (Examples): |
|---|---|
| AJ0 | adjective (unmarked) (e.g. GOOD, OLD) |
| AJC | comparative adjective (e.g. BETTER, OLDER) |
| AJS | superlative adjective (e.g. BEST, OLDEST) |
| AT0 | article (e.g. THE, A, AN) |
| AV0 | adverb (unmarked) (e.g. OFTEN, WELL, LONGER, FURTHEST) |
| AVP | adverb particle (e.g. UP, OFF, OUT) |
| AVQ | wh-adverb (e.g. WHEN, HOW, WHY) |
| CJC | coordinating conjunction (e.g. AND, OR) |
| CJS | subordinating conjunction (e.g. ALTHOUGH, WHEN) |
| CJT | the conjunction THAT |
| CRD | cardinal numeral (e.g. 3, FIFTY-FIVE, 6609) (excl ONE) |
| DPS | possessive determiner form (e.g. YOUR, THEIR) |
| DT0 | general determiner (e.g. THESE, SOME) |
| DTQ | wh-determiner (e.g. WHOSE, WHICH) |
| EX0 | existential THERE |
| ITJ | interjection or other isolate (e.g. OH, YES, MHM) |
| NN0 | noun (neutral for number) (e.g. AIRCRAFT, DATA) |
| NN1 | singular noun (e.g. PENCIL, GOOSE) |
| NN2 | plural noun (e.g. PENCILS, GEESE) |
| NP0 | proper noun (e.g. LONDON, MICHAEL, MARS) |
| NULL | the null tag (for items not to be tagged) |
| ORD | ordinal (e.g. SIXTH, 77TH, LAST) |
| PNI | indefinite pronoun (e.g. NONE, EVERYTHING) |
| PNP | personal pronoun (e.g. YOU, THEM, OURS) |
| PNQ | wh-pronoun (e.g. WHO, WHOEVER) |
| PNX | reflexive pronoun (e.g. ITSELF, OURSELVES) |
| POS | the possessive (or genitive morpheme) ‘S or ’ |
| PRF | the preposition OF |
| PRP | preposition (except for OF) (e.g. FOR, ABOVE, TO) |
| PUL | punctuation-left bracket (i.e. ( or [ ) |
| PUN | punctuation-general mark (i.e. . ! , : ; - ? . . . ) |
| PUQ | punctuation-quotation mark (i.e. ' ′ ″ ) |
| PUR | punctuation-right bracket (i.e. ) or ] ) |
| TO0 | infinitive marker TO |
| UNC | “unclassified” items which are not words of the English lexicon |
| VBB | the “base forms” of the verb “BE” (except the infinitive), i.e. |
| | AM, ARE |
| VBD | past form of the verb “BE”, i.e. WAS, WERE |
| VBG | -ing form of the verb “BE”, i.e. BEING |
| VBI | infinitive of the verb “BE” |
| VBN | past participle of the verb “BE”, i.e. BEEN |
| VBZ | -s form of the verb “BE”, i.e. IS, 'S |
| VDB | base form of the verb “DO” (except the infinitive), i.e. |
| VDD | past form of the verb “DO”, i.e. DID |
| VDG | -ing form of the verb “DO”, i.e. DOING |
| VDI | infinitive of the verb “DO” |
| VDN | past participle of the verb “DO”, i.e. DONE |
| VDZ | -s form of the verb “DO”, i.e. DOES |
| VHB | base form of the verb “HAVE” (except the infinitive), i.e. HAVE |
| VHD | past tense form of the verb “HAVE”, i.e. HAD, 'D |
| VHG | -ing form of the verb “HAVE”, i.e. HAVING |
| VHI | infinitive of the verb “HAVE” |
| VHN | past participle of the verb “HAVE”, i.e. HAD |
| VHZ | -s form of the verb “HAVE”, i.e. HAS, 'S |
| VM0 | modal auxiliary verb (e.g. CAN, COULD, WILL, 'LL) |
| VVB | base form of lexical verb (except the infinitive)(e.g. TAKE, LIVE) |
| VVD | past tense form of lexical verb (e.g. TOOK, LIVED) |
| VVG | -ing form of lexical verb (e.g. TAKING, LIVING) |
| VVI | infinitive of lexical verb |
| VVN | past participle form of lex. verb (e.g. TAKEN, LIVED) |
| VVZ | -s form of lexical verb (e.g. TAKES, LIVES) |
| XX0 | the negative NOT or N'T |
| ZZ0 | alphabetical symbol (e.g. A, B, c, d) |

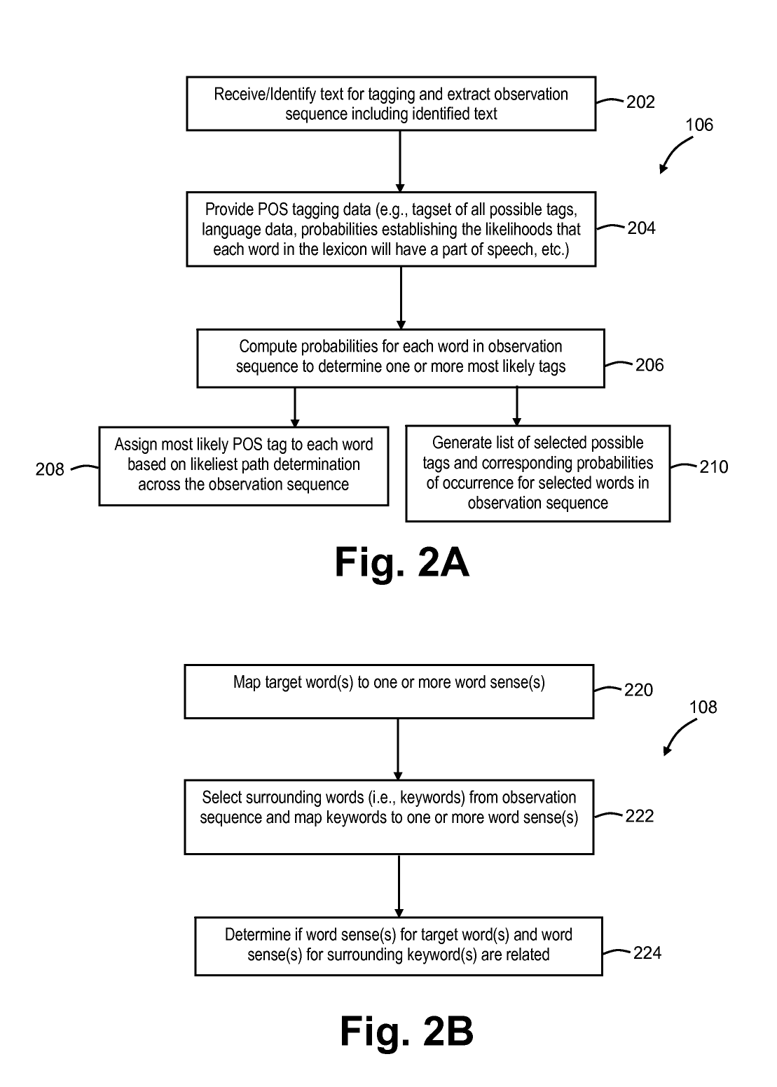

Some examples of part-of-speech tagging algorithms that can be used include but are not limited to hidden Markov models (HMMs), log-linear models, transformation-based systems, rule-based systems, memory-based systems, maximum-entropy systems, support vector systems, neural networks, decision trees, manually written disambiguation rules, path voting constraint systems, linear separator systems, and majority voting systems. The typical accuracy of POS taggers may be between 95% and 98% depending on the tagset, the size of the training corpus, the coverage of the lexicon, and the similarity between training and test data. Additional details regarding suitable examples of the part of speech tagging algorithm applied in step 106 are shown in and described with reference to FIG. 2A.

Referring now to FIG. 2A, a flow chart is presented to illustrate basic steps in one example of a part-of-speech tagging process in accordance with the present technology. A first step 202 involves identifying text to be analyzed, and extracting an observation sequence including the identified text. Usually the analyzed text (i.e., the observation sequence) will include a plurality of words strung together in one or more sentences, portions of sentences, clauses or other subset of words. Even if part-of-speech tagging is desired for only one word in an observation sequence, additional surrounding words are typically analyzed by the part-of-speech tagging algorithm to better optimize the tagging accuracy. Some of the following description may describe the observation sequence as a sentence, although it should be appreciated that other subsets of words/text may be analyzed. Step 204 involves providing POS tagging data required to perform probability analyses for the different words in the observation sequence. POS tagging data provided in step 204 may include such information as a list of all possible tags in a tagset, information identifying the number of words in the lexicon of the system, and probabilities establishing the likelihoods that each word will have a part of speech given various known uses of the word. Such probabilities may be determined by using a pre-tagged language corpus which studies the actual occurrences of various words and determines the probabilities that each word will correspond to a particular part of speech. Examples of such pre-tagged corpuses may include the Brown Corpus, American National Corpus and others.

Referring still to FIG. 2A, probability computations are then conducted in step 206 for each word in the observation sequence, such as may be implemented using the HMM based modeling techniques described below. Depending on the exact type of modeling technique used (e.g., first or second order Viterbi algorithm with or without forward-backward algorithm variations, or other models), different output steps may be implemented such as represented by steps 208 and 210. In one example, step 208 involves identifying the most likely part of speech for each word in the observation sequence, such as would be determined using a Viterbi algorithm or comparable method. In another example, step 210 involves identifying a list of possible tags and corresponding probabilities of occurrence for some or all of the words in the observation sequence. In one example, the outputs identified in step 208 are determined using a Viterbi-based algorithm, and the outputs identified in step 210 are determined using a forward-backward algorithm. A combination of steps 208 and 210 may be used to provide different outputs for a user, depending on user preferences.

Many part-of-speech tagging algorithms are based on the principles of hidden Markov models (HMMs), a well developed statistical construct used to solve state sequence classification problems in which states are interconnected by a set of transition probabilities. When using HMMs to perform part-of-speech tagging, the goal is to determine the most likely sequence of tags (states) that generates the words in a sentence or other subset of text (sequence of output symbols). In other words, given a sentence V, calculate the sequence U of tags that maximizes P(V|U). The Viterbi algorithm is a common method for calculating the most likely tag sequence when using an HMM. Particular details regarding the implementation of HMM-based tagging via the Viterbi algorithm are disclosed in “A Tutorial on Hidden Markov Models and Selected Applications in Speech Recognition,” by Lawrence R. Rabiner, Proceedings of the IEEE, Vol. 77, No. 2, February 1989, pp. 257-286. According to this implementation, there are five elements needed to define an HMM:
1. N, the number of distinct states in the model. For part of speech tagging, N is the number of tags that can be used by the system. Each possible tag for the system corresponds to one state of the HMM.
2. M, the number of distinct output symbols in the alphabet of the HMM. For part of speech tagging, M is the number of words in the lexicon of the system.
3. A={aᵢⱼ}, the state transition probability distribution. The probability aᵢⱼ is the probability that the process will move from state i to state j in one transition. For part-of-speech tagging, the states represent the tags, so aᵢⱼ is the probability that the model will move from tᵢ to tⱼ—in other words, the probability that tag tⱼ follows tᵢ. This probability can be estimated using data from a training corpus.
4. B={bⱼ(k)}, the observation symbol probability distribution. The probability bⱼ(k) is the probability that the k-th output symbol will be emitted when the model is in state j. For part-of-speech tagging, this is the probability that the word wₖ will be emitted when the system is at tag tⱼ (i.e., P(wₜ|tⱼ)). This probability can also be estimated using data from a training corpus.
5. π={πᵢ}, the initial state distribution. πᵢ is the probability that the model will start in state i. For part-of-speech tagging, this is the probability that a given sentence will begin with tag tᵢ.
   With the above information being identified, the Viterbi algorithm determines the most likely sequence of tags (states) that generates the words in the sentences (sequence of output symbols). In other words, given a sentence V, the system calculates the sequence U of tags that maximizes P(V|U). The results thus provide part-of-speech tags for a whole sentence or subset of words based on the analysis of all words in the subset. This model is an example of a first-order hidden Markov model. In part-of-speech tagging, it is called a bigram tagger.

Another example of an algorithm that can be used is a variation on the above process, implemented as a second-order Markov model or tri-gram tagger. In general, a trigram model replaces the bigram transition probability aᵢⱼ=P(tₚ=tⱼ|tₚ₋₁=tᵢ) with a trigram probability aᵢⱼₖ=P(tₚ=tₖ|tₚ₋₁=tⱼ, tₚ₋₂=tᵢ). A second-order Viterbi algorithm could then be applied to such a model using similar principles to those described above.

Variations to the bigram and trigram tagging approaches described above may also be implemented in some embodiments of the disclosed technology. For example, steps may be taken to provide information identifying a list of possible tags and their probability given the textual input sequence instead of just a single most likely tag for each word in the sequence. This additional information may help more readily disambiguate among two or more POS tags for a word. One exemplary approach for calculating such probabilities is with the so-called “Forward-Backward” algorithm (see, e.g., “Foundations of Statistical Natural Language Processing,” by C. D. Manning and H. Shutze, The MIT Press, Cambridge, Mass. (1999)). The Forward-Backward algorithm computes the sum of the probabilities of all the tag sequences where the i-th tag is t, divided by the sum of the probabilities of all tag sequences. The forward-backward algorithm can be applied as a more comprehensive analysis for either a first-order or second-order Markov model.

Referring again to FIG. 1, step 108 involves determining possible relations among the target word(s) and selected other words (i.e., keywords) in an observation sequence. It should be appreciated that the subset of words analyzed in step 108 may be the same or different than the subset of words analyzed in step 106. Step 108 facilitates an automated analysis of the context of an observation sequence to determine if any related words exist in the string of words, phrases, sentences, etc. This may help further word sense disambiguation efforts when part of speech analysis is insufficient to completely resolve ambiguities.

FIG. 2B presents a flow chart of exemplary steps that may be used in one embodiment of the relation determination of step 108. In general, the relation determination in step 108 examines the relations among words or word senses that may be stored in a database associated with the subject technology (e.g., one or more of the word sense database 406 or language database 407 illustrated in FIG. 4). A first step in the exemplary process includes step 220 of mapping the target word(s) to one or more word senses. Similarly, other selected surrounding words in an observation sequence (i.e., keywords) are mapped to one or more word senses in step 222 such that the word sense(s) of the target word(s) can be compared to the word sense(s) of the surrounding keyword(s) in step 224.

Referring still to FIG. 2B, the relation analysis in step 224 generally involves determining whether one or more types of relations exists between the word sense(s) of the target word(s) mapped in step 220 and the word sense(s) of surrounding keyword(s) mapped in step 222. Word senses can be related to one another in a plurality of different ways. For example, word sense relations can be defined in accordance with such non-limiting examples as listed in Table 2 below.

TABLE 2
Exemplary Relations among Text/Words in a
Word Sense Model Database

| Relation Type | Example |
|---|---|
| Kind of | “dog” to “mammal” |
| Part of | “finger” to “hand” |
| Instance of | “Abraham Lincoln” to “President” |
| Used by | “bat” to “batter” |
| Used in | “bat” to “baseball (the game)” |
| Done by | “strike out” to “batter” |
| Done in | “strike out” to “baseball” |
| Found in | “frog” to “pond” |
| Has attribute | “grass” to “green”; “lemon” to “sour” |
| Measure of | “large” to “size”-adjective to noun category it qualifies |
| Related to | “bat” to “Halloween”-generic relationship |
| Similar to | “large” to “immense”-loose synonyms |
| See Also | “afraid” to “cowardly”-very loose synonyms |
| Plural of | “dogs” to “dog” |
| Opposite of | “Bright” to “dark” |

Word sense relations can be considered in terms of type (e.g., kind of, part of, instance of, etc. as described above), and some of those types can be further characterized by direction (e.g., general or specific) and degree of separation (e.g., number of levels separating the related word senses). Because there are so many ways in which the relations can be defined, the determination in step 224 may be preconfigured or customized based on one or more or all of the various types of relations and/or selected limitations on the number of degrees of separation, etc.

In one embodiment of step 224, the different word sense(s) that are related to the target word sense(s) are first determined and then searched to identify if such related word senses correspond to any of the word senses mapped in step 222 for the surrounding keyword senses. In another embodiment of step 224, the word sense(s) for the target word(s) identified in step 220 and the word sense(s) for the selected surrounding keyword(s) are provided as input into a relational determining process to provide an indicator of whether the words are related as well as the specific relation(s) between the word senses. Step 224 may further involve as part of its analysis a determination of conditional probabilities that a given target word corresponds to a particular word sense given the results of the relation analysis conducted relative to surrounding words. In other words, conditional probabilities in the form pᵢ=p(senseᵢ|word, keyword context), i=1, 2, . . . , n for n different word senses are considered to choose the word sense having a greater probability of applicability. Conditional probabilities utilizing known parts of speech either given for a target word or previously determined via step 106 may also be calculated—e.g., conditional probabilities of the form pᵢ=p(senseᵢ|word, POS, keyword context), i=1, 2, . . . , n. Any of these conditional probabilities or a selection of one or more most likely word senses given the relational analysis performed in steps 220-224 are then provided back to the system for further determination of an appropriate dictionary definition.

Referring once again to FIG. 1, some or all of the probabilities or determinations from steps 106 and 108 are then used in step 110 to map a target word to one or more specific dictionary definitions. The determination in step 110 can be based on some or all of the word entry (i.e., text) itself, the part of speech analysis from step 106 (either most likely part of speech or conditional probabilities of different possible parts of speech) and the relational analysis from step 108 (either the most likely word sense given the relations among the target word and surrounding words or similar conditional probabilities). Preferably, this analysis results in the selection of a single dictionary definition, although it should be appreciated that the selection in step 110 may still result in a narrowing of possible dictionary entries to a smaller selected number. The one or more dictionary definitions selected in step 110 are then provided as electronic output to a user in step 112. In one example, such electronic output is provided by way of graphical output on a monitor display, printed output or the like. In another example, such electronic output corresponds to audio output provided by a speaker or the like.

If the information needed for mapping in step 110 cannot be determined automatically because the information such as part of speech, relational determination or other related information is unable to be determined automatically, it may be possible to prompt a user to enter such information. For example, once text is identified and a determination is made that there are multiple matching word senses in a database, a graphical user interface may be provided to a user requesting needed information (part of speech, context, etc.). Alternatively, a graphical user interface may depict the different word senses that are found and provide features by which a user can select the appropriate word sense for their intended use of the text.

To better understand steps 102-112, respectively, of FIG. 1, an example is now presented in which the subject system and method receives the text “bat” from a user as a target word for which a user wants to obtain a dictionary definition. If an electronic dictionary was consulted to determine a dictionary definition based only on the text entry for “bat” it would return multiple possible word sense entries, for example, as indicated in Table 3 below.

TABLE 3
Exemplary Dictionary Definition Information for text “bat”

| | Word | Part of | |
|---|---|---|---|
| | Sense: | Speech: | Word Sense Description: |
| (1) | Bat | Noun | a chiropteran (nocturnal mouselike mammal |
| | | | with forelimbs modified to form membranous |
| | | | wings and anatomical adaptations for |
| | | | echolocation by which they navigate) |
| (2) | Bat | Noun | a club used for hitting a ball in various |
| | | | games |
| (3) | Bat | Noun | a turn trying to get a hit at baseball |
| (4) | Bat | Verb | to strike with an elongated rod |
| (5) | Bat | Verb | to flutter or wink, as with eyelids |
| (6) | Bat | Verb | to beat thoroughly and conclusively in a |
| | | | competition or fight. |

In order to perform disambiguation among the possible entries in Table 3, the subject technology may be applied to select one or more most likely definitions. These steps may be performed as indicated in FIG. 1 by identifying an observation sequence of text or context in which “bat” was used (e.g., per step 104). In a typical situation, the observation sequence corresponds to the sentence the identified text was used in. For example, consider that the word “bat” was used in a sentence as follows: “The baseball player swung the bat like he was in the World Series.” Some or all of this sentence may then be subjected to a part of speech tagging algorithm in step 106 to determine that the word “bat” identified in step 102 is a singular noun. If the part of speech information was used by itself for the subject dictionary definition disambiguation, then the dictionary definitions in Table 3 could be narrowed down from six possibilities to three—namely, entries (1), (2) and (3). To further facilitate disambiguation efforts, additional relational analysis in step 108 may be conducted by comparing potential relations between the target word “bat” and surrounding words in the sentence, e.g., one or more of “baseball,” “player,” “swung,” and “World Series.”

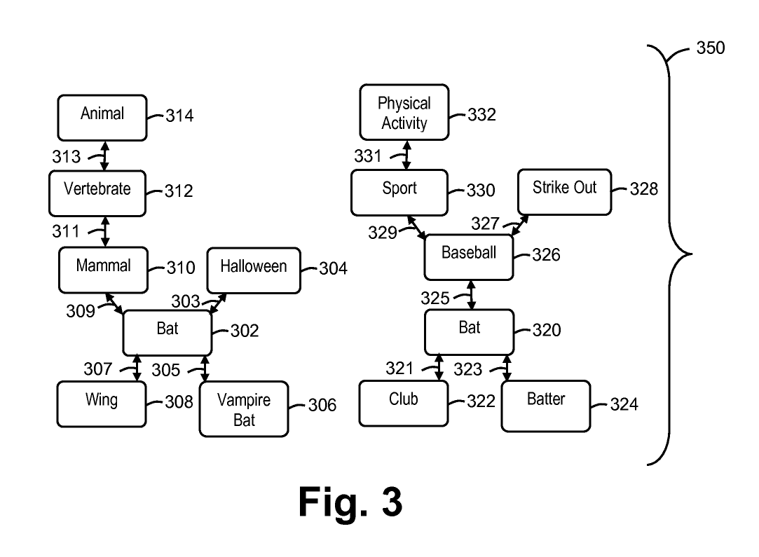

FIG. 3 shows an exemplary schematic network 350 depicting a subset of relations that may exist for different word senses for the word “bat” and other related word senses. For example, assuming that word sense 302 for “bat” corresponds to the first entry in Table 3 for a nocturnal mouse-like mammal, “bat” 302 may be related to such other word senses as “Halloween” 304, “vampire bat” 306, “wing” 308, and “mammal” 310. The types of relations shown in FIG. 3 are varied. For example, “bat” 302 is related to “Halloween” 304 as a “related to” relation 303 since bat and Halloween are generally related. “Bat” 302 is related to “vampire bat” 306 as a “kind of” relation 305 since a vampire bat is a specific kind of a bat. “Bat” 302 is related to “wing” 308 as a “part of” relation 307 since a wing is a part of a bat. “Bat” 302 is related to “mammal” 310 as a “kind of” relation 309 since a bat is a kind of a mammal. “Mammal” 310 is related to “vertebrate” 312 as a “kind of” relation 311 since a mammal is a kind of a vertebrate, and “vertebrate” 312 is related to “animal” 314 as a “kind of” relation 313 since a vertebrate is a kind of an animal. Relations 303, 305, 307 and 309 may be considered direct relations (i.e., relations between two word senses without having an intermediate relation). However, indirect relations (i.e., relations spanning over two or more degrees of separation) may also be evaluated per step 108. In FIG. 3, “bat” 302 may be indirectly related to “vertebrate” 312 since they are separated by two degrees of relational separation—first by “kind of” relation 309 and second by “kind of” relation 311. “Bat” 302 may also be indirectly related to “animal” 314 since they are separated by three degrees of relational separation, the “kind of” relations 309, 311 and 313.

Referring still to FIG. 3, similar word sense relations may exist for another word sense entry for “bat” 320, corresponding to the second entry in Table 3 for a club used for hitting a ball. “Bat” 320 may be directly related to senses “club” 322, “batter” 324, and “baseball” 326 by respective relations 321, 323 and 325. Relation 321 may be considered a “similar to” relation since a bat is similar to a club. Relation 323 may be considered a “used by” relation since a bat is used by a batter. Relation 325 may be considered a “used in” relation since a bat is used in the sport of baseball. “Bat” 320 may be further indirectly related to “strike out” 328, “sport” 330 and “physical activity” 332 via respective relations 327, 329 and 331. Relation 327 may be considered a “done in” relation since a strike out is done in the sport of baseball. Relations 329 and 331 may be considered “kind of” relations since baseball is a kind of a sport and a sport is a kind of a physical activity.

Based on the exemplary relations for different word senses of the noun form of the word “bat” (partial examples of which are illustrated schematically in FIG. 3), the relational analysis performed in step 108 may identify that there is a relation between the word senses “bat” 320 and “baseball” 326 but not between word sense “bat” 302 and any of the other surrounding words in the sentence: “The baseball player swung the bat like he was in the World Series.” This relational analysis may result in a selection of the word sense “bat” 320 over “bat” 302. It may alternatively result in specific conditional probability outputs for both or still further word senses based on the different relations that are determined.

If the analysis of both steps 106 and 108 are utilized in determining one or more dictionary definitions in step 110, the system will know that the text “bat” is being used in context as a singular noun and that a relation exists for “baseball” to even fewer possible word senses for the text “bat.” This information could result in a determination of the most likely word sense mapping of “bat” to entry (2) in Table 3 or alternatively to a mapping to both entries (2) and (3) in Table 3. The particular dictionary definition displayed as output for a user may thus correspond to “bat”—“a club used for hitting a ball in various games.”

Referring now to FIGS. 4 and 5, additional details regarding possible hardware components that may be provided to accomplish the methodology described with respect to FIGS. 1-3 are discussed.

FIG. 4 discloses an exemplary electronic device 400, which may correspond to any general electronic device including such components as a computing device 401, an input device 410 and an output device 412. In more specific examples, electronic device 400 may correspond to a mobile computing device, a handheld computer, a mobile phone, a cellular phone, a VoIP phone, a smart phone, a personal digital assistant (PDA), a BLACKBERRY™ device, a TREO™, an iPhone™, an iTouch™, a media player, a navigation device, an e-mail device, a game console or other portable electronic device, a stand-alone computer terminal such as a desktop computer, a laptop computer, a netbook computer, a palmtop computer, or a combination of any two or more of the above or other data processing devices.

Referring more particularly to the exemplary hardware shown in FIG. 4, a computing device 401 is provided to function as the central controller within the electronic device 400 and may generally include such components as at least one memory/media element or database for storing data and software instructions as well as at least one processor. In the particular example of FIG. 4, one or more processor(s) 402 and associated memory/media devices 404a, 404b and 404c are configured to perform a variety of computer-implemented functions (i.e., software-based data services). One or more processor(s) 402 within computing device 401 may be configured for operation with any predetermined operating systems, such as but not limited to Windows XP, and thus is an open system that is capable of running any application that can be run on Windows XP. Other possible operating systems include BSD UNIX, Darwin (Mac OS X), Linux, SunOS (Solaris/OpenSolaris), and Windows NT (XP/Vista/7).

At least one memory/media device (e.g., device 404a in FIG. 4) is dedicated to storing software and/or firmware in the form of computer-readable and executable instructions that will be implemented by the one or more processor(s) 402. Other memory/media devices (e.g., memory/media devices 404b and/or 404c as well as databases 406, 407 and 408) are used to store data which will also be accessible by the processor(s) 402 and which will be acted on per the software instructions stored in memory/media device 404a. Computing/processing device(s) 402 may be adapted to operate as a special-purpose machine by executing the software instructions rendered in a computer-readable form stored in memory/media element 404a. When software is used, any suitable programming, scripting, or other type of language or combinations of languages may be used to implement the teachings contained herein. In other embodiments, the methods disclosed herein may alternatively be implemented by hard-wired logic or other circuitry, including, but not limited to application-specific integrated circuits.

The various memory/media devices of FIG. 4 may be provided as a single portion or multiple portions of one or more varieties of computer-readable media, such as but not limited to any combination of volatile memory (e.g., random access memory (RAM, such as DRAM, SRAM, etc.)) and nonvolatile memory (e.g., ROM, flash, hard drives, magnetic tapes, CD-ROM, DVD-ROM, etc.) or any other memory devices including diskettes, drives, other magnetic-based storage media, optical storage media and others. In some embodiments, at least one memory device corresponds to an electromechanical hard drive and/or or a solid state drive (e.g., a flash drive) that easily withstands shocks, for example that may occur if the electronic device 400 is dropped. Although FIG. 4 shows three separate memory/media devices 404a, 404b and 404c, and three separate databases 406, 407 and 408, the content dedicated to such devices may actually be stored in one memory/media device or in multiple devices. Any such possible variations and other variations of data storage will be appreciated by one of ordinary skill in the art.

In one particular embodiment of the present subject matter, memory/media device 404b is configured to store input data received from a user, such as but not limited to information corresponding to or identifying target word(s), observation sequence(s) or other text (e.g., one or more words, phrases, acronyms, identifiers, etc.) for performing the desired dictionary definition lookup. Such input data may be received from one or more integrated or peripheral input devices 410 associated with electronic device 400, including but not limited to a keyboard, joystick, switch, touch screen, microphone, eye tracker, camera, or other device. Memory device 404a includes computer-executable software instructions that can be read and executed by processor(s) 402 to act on the data stored in memory/media device 404b to create new output data (e.g., audio signals, display signals, RF communication signals and the like) for temporary or permanent storage in memory, e.g., in memory/media device 404c. Such output data may be communicated to integrated and/or peripheral output devices, such as a monitor or other display device, speaker, printer or as control signals to still further components.

Additional actions taken by the processor(s) 402 within computing device 401 may access and/or analyze data stored in one or more databases, such as word sense database 406, language database 407 and dictionary database 408, which may be provided locally relative to computing device 401 (as illustrated in FIG. 4) or in a remote location accessible via a wired and/or wireless communication link.

In general, word sense database 406 and language database 407 work together to define all the informational characteristics of a given text/word. Word sense database 406 stores a plurality of entries that identify the different possible meanings for various text/word items, while the actual language-specific identifiers for such meanings (i.e., the words themselves) are stored in language database 407. The entries in the word sense database 406 are thus cross-referenced to entries in language database 407 which provide the actual labels for a word sense. As such, word sense database 406 generally stores semantic information about a given word while language database 407 generally stores the lexical information about a word.

The basic structure of the databases 406 and 407 is such that the word sense database is effectively language-neutral. Because of this structure and the manner in which the word sense database 406 functionally interacts with the language database 407, different language databases (e.g., English, French, German, Spanish, Chinese, Japanese, etc.) can be used to map to the same word sense entries stored in word sense database 406. Considering again the “bat” example, an entry for “bat” in an English language database (one particular embodiment of language database 407) may be cross-referenced to six different entries in word sense database 406, all of which are outlined in Table 3 above. However, an entry for “chauve-souris” in a French language database 407 (another particular embodiment of language database 407) would be linked to the first word sense in Table 2 correlating the semantic meaning of a nocturnal mouselike mammal, while an entry for “batte” in the same French language database would be linked to the second word sense in Table 2 correlating the meaning of a club used for hitting a ball.

The word sense database 406 also stores information defining the relations among the various word senses. For example, an entry in word sense database 406 may also store information associated with the word entry defining which word senses it is related to by various predefined relations as described above in Table 2. It should be appreciated that although relation information is stored in word sense database 406 in one exemplary embodiment, other embodiments may store such relation information in other databases such as the language database 407 or dictionary database 408, or yet another database specifically dedicated to relation information, or a combination of one or more of these and other databases.

The language database 407 may also store related information for each word entry. For example, optional additional lexical information such as but not limited to parts of speech, different regular and/or irregular forms of such words, pronunciations and the like may be stored in language database 407. For each word, probabilities for part of speech analysis as determined from a tagged corpus such as but not limited to the Brown corpus, American National Corpus, etc., may also be stored in language database 407. Part of speech data for each entry in a language database may also be provided from customized or preconfigured tagset sources. Nonlimiting examples of part of speech tagsets that could be used for analysis in the subject text mapping and analysis are the Penn Treebank documentation (as defined by Marcus et al., 1993, “Building a large annotated corpus of English: The Penn Treebank,” Computational Linguistics, 19(2): 313-330), and the CLAWS (Constituent Likelihood Automatic Word-tagging System) series of tagsets (e.g., CLAWS4, CLAWS5, CLAWS6, CLAWS7) developed by UCREL of Lancaster University in Lancaster, United Kingdom.

In some embodiments of the subject technology, the information stored in word sense database 406 and language database 407 is customized according to the needs of a user and/or device. In other embodiments, preconfigured collective databases may be used to provide the information stored within databases 406 and 407. Non-limiting examples of preconfigured lexical and semantic databases include the WordNet lexical database created and currently maintained by the Cognitive Science Laboratory at Princeton University of Princeton, N.J., the Semantic Network distributed by UMLS Knowledge Sources and the U.S. National Library of Medicine of Bethesda, Md., or other preconfigured collections of lexical relations. Such lexical databases and others store groupings of words into sets of synonyms that have short, general definitions, as well as the relations between such sets of words.

Dictionary database 408 may include the actual dictionary definitions for each word sense and may be stored with pointers to entries in either or both of the word sense database 406 and language database 407. In other embodiments, it should be appreciated that the dictionary definitions may be stored along with the entries in either or both of the word sense database 406 and 407. If the entries in dictionary database 408 are cross-referenced to entries in the language database, a single entry in the language database 407 will often be linked to multiple possible dictionary definitions in dictionary database 408 (e.g., the word entry “bat” can have any one of the possible definitions presented in Table 2 above). However, if the entries in dictionary database 408 are cross-referenced to entries in the word sense database 406, a single entry in word sense database 406 will preferably be linked to only one or to a limited number of possible dictionary definitions in database 408 (e.g., the word sense defining “bat” as a flying mouse-like mammal may only have one definition in dictionary database 408.)

It should be appreciated that the hardware components illustrated in and discussed with reference to FIG. 4 may be selectively combined with additional components to create different electronic device embodiments for use with the presently disclosed dictionary definition technology. For example, the same or similar components provided in FIG. 4 may be integrated as part of a speech generation device (SGD) or AAC device 500, as shown in the example of FIG. 5. AAC device 500 may correspond to a variety of devices such as but not limited to a device such as offered for sale by DynaVox Mayer-Johnson of Pittsburgh, Pa. including but not limited to the V, Vmax, Xpress, Tango, M³ and/or DynaWrite products or any other suitable component adapted with the features and functionality disclosed herein.

Central computing device 501 may include all or part of the functionality described above with respect to computing device 401, and so a description of such functionality is not repeated. Memory device or database 504a of FIG. 5 may include some of all of the memory elements 404a, 404b and/or 404c as described above relative to FIG. 4. Memory device or database 504b of FIG. 5 may include some or all of the databases 406, 407 and 408 described above relative to FIG. 4. Input device 410 and output device 412 may correspond to one or more the input and output devices described below relative to FIG. 5.

Referring still to FIG. 5, central computing device 501 also may include a variety of internal and/or peripheral components in addition to similar components as described with reference to FIG. 4. Power to such devices may be provided from a battery 503, such as but not limited to a lithium polymer battery or other rechargeable energy source. A power switch or button 505 may be provided as an interface to toggle the power connection between the battery 503 and the other hardware components. In addition to the specific devices discussed herein, it should be appreciated that any peripheral hardware device 507 may be provided and interfaced to the speech generation device via a USB port 509 or other communicative coupling. It should be further appreciated that the components shown in FIG. 5 may be provided in different configurations and may be provided with different arrangements of direct and/or indirect physical and communicative links to perform the desired functionality of such components.

In general, the electronic components of an SGD 500 enable the device to transmit and receive messages to assist a user in communicating with others. For example, the SGD may correspond to a particular special-purpose electronic device that permits a user to communicate with others by producing digitized or synthesized speech based on configured messages. Such messages may be preconfigured and/or selected and/or composed by a user within a message window provided as part of the speech generation device user interface. As will be described in more detail below, a variety of physical input devices and software interface features may be provided to facilitate the capture of user input to define what information should be displayed in a message window and ultimately communicated to others as spoken output, text message, phone call, e-mail or other outgoing communication.

With more particular reference to exemplary speech generation device 500 of FIG. 5, various input devices may be part of an SGD 500 and thus coupled to the computing device 501. For example, a touch screen 506 may be provided to capture user inputs directed to a display location by a user hand or stylus. A microphone 508, for example a surface mount CMOS/MEMS silicon-based microphone or others, may be provided to capture user audio inputs. Other exemplary input devices (e.g., peripheral device 510) may include but are not limited to a peripheral keyboard, peripheral touch-screen monitor, peripheral microphone, mouse and the like. A camera 519, such as but not limited to an optical sensor, e.g., a charged coupled device (CCD) or a complementary metal-oxide semiconductor (CMOS) optical sensor, or other device can be utilized to facilitate camera functions, such as recording photographs and video clips, and as such may function as another input device. Hardware components of SGD 500 also may include one or more integrated output devices, such as but not limited to display 512 and/or speakers 514.

Display device 512 may correspond to one or more substrates outfitted for providing images to a user. Display device 512 may employ one or more of liquid crystal display (LCD) technology, light emitting polymer display (LPD) technology, light emitting diode (LED), organic light emitting diode (OLED) and/or transparent organic light emitting diode (TOLED) or some other display technology. Additional details regarding OLED and/or TOLED displays for use in SGD 500 are disclosed in U.S. Provisional Patent Application No. 61/250,274 filed Oct. 9, 2009 and entitled “Speech Generation Device with OLED Display,” which is hereby incorporated herein by reference in its entirety for all purposes.

In one exemplary embodiment, a display device 512 and touch screen 506 are integrated together as a touch-sensitive display that implements one or more of the above-referenced display technologies (e.g., LCD, LPD, LED, OLED, TOLED, etc.) or others. The touch sensitive display can be sensitive to haptic and/or tactile contact with a user. A touch sensitive display that is a capacitive touch screen may provide such advantages as overall thinness and light weight. In addition, a capacitive touch panel requires no activation force but only a slight contact, which is an advantage for a user who may have motor control limitations. Capacitive touch screens also accommodate multi-touch applications (i.e., a set of interaction techniques which allow a user to control graphical applications with several fingers) as well as scrolling. In some implementations, a touch-sensitive display can comprise a multi-touch-sensitive display. A multi-touch-sensitive display can, for example, process multiple simultaneous touch points, including processing data related to the pressure, degree, and/or position of each touch point. Such processing facilitates gestures and interactions with multiple fingers, chording, and other interactions. Other touch-sensitive display technologies also can be used, e.g., a display in which contact is made using a stylus or other pointing device. Some examples of multi-touch-sensitive display technology are described in U.S. Pat. Nos. 6,323,846 (Westerman et al.), 6,570,557 (Westerman et al.), 6,677,932 (Westerman), and 6,888,536 (Westerman et al.), each of which is incorporated by reference herein in its entirety for all purposes.

Speakers 514 may generally correspond to any compact high power audio output device. Speakers 514 may function as an audible interface for the speech generation device when computer processor(s) 502 utilize text-to-speech functionality. Speakers can be used to speak the messages composed in a message window as described herein as well as to provide audio output for telephone calls, speaking e-mails, reading e-books, and other functions. A volume control module 522 may be controlled by one or more scrolling switches or touch-screen buttons.

SGD hardware components also may include various communications devices and/or modules, such as but not limited to an antenna 515, cellular phone or RF device 516 and wireless network adapter 518. Antenna 515 can support one or more of a variety of RF communications protocols. A cellular phone or other RF device 516 may be provided to enable the user to make phone calls directly and speak during the phone conversation using the SGD, thereby eliminating the need for a separate telephone device. A wireless network adapter 518 may be provided to enable access to a network, such as but not limited to a dial-in network, a local area network (LAN), wide area network (WAN), public switched telephone network (PSTN), the Internet, intranet or ethernet type networks or others. Additional communications modules such as but not limited to an infrared (IR) transceiver may be provided to function as a universal remote control for the SGD that can operate devices in the user's environment, for example including TV, DVD player, and CD player.

When different wireless communication devices are included within an SGD, a dedicated communications interface module 520 may be provided within central computing device 501 to provide a software interface from the processing components of computer 501 to the communication device(s). In one embodiment, communications interface module 520 includes computer instructions stored on a computer-readable medium as previously described that instruct the communications devices how to send and receive communicated wireless or data signals. In one example, additional executable instructions stored in memory associated with central computing device 501 provide a web browser to serve as a graphical user interface for interacting with the Internet or other network. For example, software instructions may be provided to call preconfigured web browsers such as Microsoft® Internet Explorer or Firefox® internet browser available from Mozilla software.

Antenna 515 may be provided to facilitate wireless communications with other devices in accordance with one or more wireless communications protocols, including but not limited to BLUETOOTH, WI-FI (802.11b/g), MiFi and ZIGBEE wireless communication protocols. In one example, the antenna 515 enables a user to use the SGD 500 with a Bluetooth headset for making phone calls or otherwise providing audio input to the SGD. The SGD also can generate Bluetooth radio signals that can be used to control a desktop computer, which appears on the SGD's display as a mouse and keyboard. Another option afforded by Bluetooth communications features involves the benefits of a Bluetooth audio pathway. Many users utilize an option of auditory scanning to operate their SGD. A user can choose to use a Bluetooth-enabled headphone to listen to the scanning, thus affording a more private listening environment that eliminates or reduces potential disturbance in a classroom environment without public broadcasting of a user's communications. A Bluetooth (or other wirelessly configured headset) can provide advantages over traditional wired headsets, again by overcoming the cumbersome nature of the traditional headsets and their associated wires.

When an exemplary SGD embodiment includes an integrated cell phone, a user is able to send and receive wireless phone calls and text messages. The cell phone component 516 shown in FIG. 5 may include additional sub-components, such as but not limited to an RF transceiver module, coder/decoder (CODEC) module, digital signal processor (DSP) module, communications interfaces, microcontroller(s) and/or subscriber identity module (SIM) cards. An access port for a subscriber identity module (SIM) card enables a user to provide requisite information for identifying user information and cellular service provider, contact numbers, and other data for cellular phone use. In addition, associated data storage within the SGD itself can maintain a list of frequently-contacted phone numbers and individuals as well as a phone history or phone call and text messages. One or more memory devices or databases within a speech generation device may correspond to computer-readable medium that may include computer-executable instructions for performing various steps/tasks associated with a cellular phone and for providing related graphical user interface menus to a user for initiating the execution of such tasks. The input data received from a user via such graphical user interfaces can then be transformed into a visual display or audio output that depicts various information to a user regarding the phone call, such as the contact information, call status and/or other identifying information. General icons available on SGD or displays provided by the SGD can offer access points for quick access to the cell phone menus and functionality, as well as information about the integrated cell phone such as the cellular phone signal strength, battery life and the like.

Operation of the hardware components shown in FIGS. 4 and 5 can enable an electronic device or specific speech generation device to “speak” a dictionary definition identified by the present automated system. Speaking consists of playing a recorded message or sound or speaking text using a voice synthesizer. The identified target word(s) and identified dictionary definition(s) may be interpreted by a text-to-speech engine and provided as audio output via device speakers. Speech output may be generated in accordance with one or more preconfigured text-to-speech generation tools in male or female and adult or child voices, such as but not limited to such products as offered for sale by Cepstral, HQ Voices offered by Acapela, Flexvoice offered by Mindmaker, DECtalk offered by Fonix, Loquendo products, VoiceText offered by NeoSpeech, products by AT&T's Natural Voices offered by Wizzard, Microsoft Voices, digitized voice (digitally recorded voice clips) or others.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method of automatically selecting electronic dictionary definitions for one or more target words, comprising:
receiving electronic signals from an input device indicating one or more target words for which a dictionary definition is desired;
electronically assigning one or more most likely part of speech tags for the one or more target words;
electronically determining relations among the one or more target words and selected surrounding keywords;
electronically mapping the one or more target words to one or more specific dictionary definitions based on each target word, one or more most likely part of speech tags and the determined relations between each target word and selected surrounding keywords; and
providing the one or more specific dictionary definitions as physical output to a user.

2. The method of claim 1, wherein said providing step comprises displaying the one or more target words and the one or more specific dictionary definitions on an electronic display device.

3. The method of claim 1, wherein said providing step comprises providing the one or more target words and the one or more specific dictionary definitions as audio output to a user.

4. The method of claim 1, wherein the part of speech tags from said electronically assigning step are selected from a tagset indicating basic parts of speech as well as syntactic or morpho-syntactic distinctions.

5. The method of claim 1, wherein said step of electronically assigning one or more most likely part of speech tags for the one or more target words comprises:
extracting an observation sequence of text including the identified text and surrounding words; and
assigning the most likely part of speech tag for each word in the observation sequence.

6. The method of claim 5, wherein said assigning step comprises employing a first-order or second-order Viterbi algorithm to assign part of speech tags.

7. The method of claim 1, wherein said step of electronically assigning one or more most likely part of speech tags for the one or more target words comprises:
extracting an observation sequence of text including the identified text and surrounding words; and
generating a list of possible tags and corresponding probabilities of occurrence for the one or more words in the identified text.

8. The method of claim 1, wherein said step of electronically assigning one or more most likely part of speech tags for the one or more target words comprises employing one or more of a first-order Viterbi algorithm, a second-order Viterbi algorithm and a forward-backward algorithm to assign one or more most likely part of speech tags for the one or more target words.

9. The method of claim 1, further comprising displaying multiple dictionary definitions on a graphical user interface for subsequent user selection and electronic output when multiple dictionary definitions are identified in said electronically mapping step.

10. The method of claim 1, wherein said step of electronically determining relations among the one or more target words and selected surrounding keywords comprises:
mapping the one or more target words to one or more word senses;
selecting keywords from an observation sequence including the one or more target words and surrounding words;
mapping the selected keywords to one or more word senses; and
determining if the one or more word senses for the one or more target words and the one or more word senses for the selected keywords are related.

11. The method of claim 1, wherein said step of electronically determining relations among the one or more target words and selected surrounding keywords comprises determining conditional probabilities that a given target word corresponds to a particular word sense given relational analysis conducted relative to the selected surrounding keywords.

12. An electronic device, comprising:
at least one electronic input device configured to receive electronic input from a user indicating one or more target words for which a dictionary definition is desired;
at least one processing device;
at least one memory comprising computer-readable instructions for execution by said at least one processing device, wherein said processing device is configured to assign one or more most likely part of speech tags for the one or more target words, determine relations among the one or more target words and selected surrounding keywords, and map the one or more target words to one or more specific dictionary definitions based on each target word, the one or more most likely part of speech tags and the determined relations between each target word and selected surrounding keywords; and
at least one electronic output device configured to provide the one or more specific dictionary definitions as electronic output.

13. The electronic device of claim 12, wherein said electronic device comprises a speech generation device that comprises at least one speaker for providing audio output, and wherein the one or more specific dictionary definitions are provided as audio output to a user via said at least one speaker.

14. The electronic device of claim 12, wherein said at least one electronic output device comprises a monitor, and wherein the one or more specific dictionary definitions are provided as visual output to a user via said monitor.

15. The electronic device of claim 12, wherein the part of speech tags from said electronically assigning step are selected from a tagset indicating basic parts of speech as well as syntactic or morpho-syntactic distinctions.

16. The electronic device of claim 12, wherein said at least one processing device is configured to assign one or more most likely part of speech tags for the one or more target words by extracting an observation sequence of text including the identified text and surrounding words, and assigning the most likely part of speech tag for each word in the observation sequence.

17. The electronic device of claim 12, wherein said at least one processing device is configured to assign one or more most likely part of speech tags for the one or more target words by extracting an observation sequence of text including the identified text and surrounding words, and generating a list of possible tags and corresponding probabilities of occurrence for the one or more words in the identified text.

18. The electronic device of claim 12, wherein said processing device is configured to employ one or more of a first-order Viterbi algorithm, a second-order Viterbi algorithm and a forward-backward algorithm to assign one or more most likely part of speech tags for the one or more target words.

19. The electronic device of claim 12, wherein said at least one electronic output device is further configured to display multiple dictionary definitions on a graphical user interface for subsequent user selection and electronic output when multiple dictionary definitions are mapped to the one or more target words.

20. The electronic device of claim 12, wherein said processing device is further configured as part of determining relations among the one or more target words and selected surrounding keywords to:
map the one or more target words to one or more word senses;
select keywords from an observation sequence including the one or more target words and surrounding words;
map the selected keywords to one or more word senses; and
determine if the one or more word senses for the one or more target words and the one or more word senses for the selected keywords are related.

21. The electronic device of claim 12, wherein said processing device is further configured as part of determining relations among the one or more target words and selected surrounding keywords to determine conditional probabilities that a given target word corresponds to a particular word sense given relational analysis conducted relative to the selected surrounding keywords.

22. A computer readable medium comprising executable instructions configured to control a processing device to:
receive electronic signals from an input device indicating one or more target words for which a dictionary definition is desired;
electronically assign one or more most likely part of speech tags for the one or more target words;
electronically determine relations among the one or more target words and selected surrounding keywords;
electronically map the one or more target words to one or more specific dictionary definitions based on each target word, one or more most likely part of speech tags and the determined relations between each target word and selected surrounding keywords; and
provide the one or more specific dictionary definitions as physical output to a user.

23. The computer readable medium of claim 22, wherein said executable instructions are further configured to assign part of speech tags by selecting tags from a tagset indicating basic parts of speech as well as syntactic or morpho-syntactic distinctions.

24. The computer readable medium of claim 22, wherein said executable instructions are further configured to assign one or more most likely part of speech tags for the one or more target words by extracting an observation sequence of text including the identified text and surrounding words, and assigning the most likely part of speech tag for each word in the observation sequence.

25. The computer readable medium of claim 22, wherein said executable instructions are further configured to assign one or more most likely part of speech tags for the one or more target words by extracting an observation sequence of text including the identified text and surrounding words, and generating a list of possible tags and corresponding probabilities of occurrence for the one or more words in the identified text.

26. The computer readable medium of claim 22, wherein said executable instructions are further configured to employ one or more of a first-order Viterbi algorithm, a second-order Viterbi algorithm and a forward-backward algorithm to assign one or more most likely part of speech tags for the one or more target words.
